(19) United States
(12) Patent Application Publication
(10) Pub. No.: US 2025/0292300 A1
(43) Pub. Date: Sep. 18, 2025

(54) SYSTEMS AND METHODS FOR AUTOMATED QUALIFICATION ANALYSIS

(71) Applicant: Synchrony Bank, Stamford, CT (US)

(72) Inventors: SurendraNag Mandalaneni, Stamford, CT (US); William Kievit, Stamford, CT (US); Jake Miller, Stamford, CT (US); Joseph Gauthier, Stamford, CT (US); Natalie Bayer, Stamford, CT (US); Florin Arghirescu, Stamford, CT (US); Seamus Sullivan, Stamford, CT (US); Nayan Sharma, Stamford, CT (US); Sarath Vadakapurapu, Stamford, CT (US)

(21) Appl. No.: 18/758,703

(22) Filed: Jun. 28, 2024

Related U.S. Application Data
(60) Provisional application No. 63/564,163, filed on Mar. 12, 2024.

(51) Int. Cl. G06Q 30/0601; G06Q 40/03

(52) U.S. Cl. CPC G06Q 30/0621; G06Q 30/0631; G06Q 40/03

(57) ABSTRACT

Qualification decisioning systems and techniques are described. For instance, a system receives user information that is indicative of a user's income stream and/or asset(s). The system receives product qualification criteria data corresponding to products, with different products corresponding to different product-specific qualification criteria. The product qualification criteria data can change over time. The system dynamically analyzes the user information and the product qualification criteria data using a trained machine learning (ML) model in real-time as the user information and the product qualification criteria data continue to be received. The trained ML model identifies a subset of the plurality of products that the user qualifies for at a specific time. The system outputs recommendations for the subset of the plurality of products. The system dynamically trains the trained ML model further, using the recommendations and the user information as training data, to update the trained ML model for future qualification decisions.

### CROSS-REFERENCE TO RELATED APPLICATIONS

The present invention claims the priority benefit of U.S. provisional patent application No. 63/564,163 filed Mar. 12, 2024 and titled “Systems and Methods for Automated Qualification Analysis,” the disclosure of which is incorporated by reference herein.

### FIELD

This disclosure is related to automated enrollment orchestration onto a transaction processing system. More specifically, this disclosure relates to systems and methods of generating and/or customizing a configuration for an offering based on previously-generated configuration(s) for product type(s), partner(s), merchant(s), and the like.

### BACKGROUND

A qualification system can analyze information about a user and identify whether the user qualifies for a specific product, such as a credit card or a loan. In some situations, multiple products might be able to serve a user's needs. However, traditionally, different products have different qualification systems, with each operating separately.

### BRIEF SUMMARY

Systems and techniques are described for qualification decisioning. In some examples, a system receives user information that is indicative of a user's income stream and/or asset(s). The system receives product qualification criteria data corresponding to products, with different products corresponding to different product-specific qualification criteria. The product qualification criteria data can change over time. The system dynamically analyzes the user information and the product qualification criteria data using a trained machine learning (ML) model in real-time as the user information and the product qualification criteria data continue to be received. The trained ML model identifies a subset of the plurality of products that the user qualifies for at a specific time. The system outputs recommendations for the subset of the plurality of products. The system dynamically trains the trained ML model further, using the recommendations and the user information as training data, to update the trained ML model for future qualification decisions.

According to at least one example, a method is provided for multi-product qualification analysis. The method includes: receiving user information that is indicative of an income stream of a user and an asset associated with the user, wherein the user information continues to be received over time; receiving product qualification criteria data corresponding to a plurality of products, wherein different products of the plurality of products correspond to different product-specific qualification criteria of the product qualification criteria data, wherein the product qualification criteria data changes over time; dynamically analyzing the user information and the product qualification criteria data, wherein the analyzing includes using a trained machine learning (ML) model in real-time as the user information and the product qualification criteria data continue to be received, and wherein the trained ML model identifies a qualification decision indicating a subset of the plurality of products that the user qualifies for at a specific time; outputting recommendations for the subset of the plurality of products; and dynamically training the trained machine learning model further in real-time, wherein dynamically training includes using the recommendations and the user information as training data as the user information continues to be received, and wherein the trained machine learning model is trained further to update the trained machine learning model for future qualification decisions.

In another example, an apparatus for multi-product qualification analysis is provided that includes at least one memory and at least one processor coupled to the at least one memory. The at least one processor is configured to: receive user information that is indicative of an income stream of a user and an asset associated with the user, wherein the user information continues to be received over time; receive product qualification criteria data corresponding to a plurality of products, wherein different products of the plurality of products correspond to different product-specific qualification criteria of the product qualification criteria data, wherein the product qualification criteria data changes over time; dynamically analyze the user information and the product qualification criteria data, wherein the analyzing includes using a trained machine learning (ML) model in real-time as the user information and the product qualification criteria data continue to be received, and wherein the trained ML model identifies a qualification decision indicating a subset of the plurality of products that the user qualifies for at a specific time; output recommendations for the subset of the plurality of products; and dynamically train the trained machine learning model further in real-time, wherein dynamically training includes using the recommendations and the user information as training data as the user information continues to be received, and wherein the trained machine learning model is trained further to update the trained machine learning model for future qualification decisions.

In another example, a non-transitory computer-readable medium is provided that has stored thereon instructions that, when executed by one or more processors, cause the one or more processors to: receive user information that is indicative of an income stream of a user and an asset associated with the user, wherein the user information continues to be received over time; receive product qualification criteria data corresponding to a plurality of products, wherein different products of the plurality of products correspond to different product-specific qualification criteria of the product qualification criteria data, wherein the product qualification criteria data changes over time; dynamically analyze the user information and the product qualification criteria data, wherein the analyzing includes using a trained machine learning (ML) model in real-time as the user information and the product qualification criteria data continue to be received, and wherein the trained ML model identifies a qualification decision indicating a subset of the plurality of products that the user qualifies for at a specific time; output recommendations for the subset of the plurality of products; and dynamically train the trained machine learning model further in real-time, wherein dynamically training includes using the recommendations and the user information as training data as the user information continues to be received, and wherein the trained machine learning model is trained further to update the trained machine learning model for future qualification decisions.

In another example, an apparatus for multi-product qualification analysis is provided. The apparatus includes: means for receiving user information that is indicative of an income stream of a user and an asset associated with the user, wherein the user information continues to be received over time; means for receiving product qualification criteria data corresponding to a plurality of products, wherein different products of the plurality of products correspond to different product-specific qualification criteria of the product qualification criteria data, wherein the product qualification criteria data changes over time; means for dynamically analyzing the user information and the product qualification criteria data, wherein the analyzing includes using a trained machine learning (ML) model in real-time as the user information and the product qualification criteria data continue to be received, and wherein the trained ML model identifies a qualification decision indicating a subset of the plurality of products that the user qualifies for at a specific time; means for outputting recommendations for the subset of the plurality of products; and means for dynamically training the trained machine learning model further in real-time, wherein dynamically training includes using the recommendations and the user information as training data as the user information continues to be received, and wherein the trained machine learning model is trained further to update the trained machine learning model for future qualification decisions.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a block diagram illustrating an example architecture of a multi-product qualification analysis system that analyzes a single set of user information based on multiple sets of product qualification criteria to determine eligibility of a user for multiple different products, in accordance with some examples;

FIG. 2 is a conceptual diagram illustrating examples of user interfaces for obtaining user information associated with a user and providing an ordered list of recommendations for products that the user is qualified for, with the order of the list being based on one or more factors, in accordance with some examples;

FIG. 3 is a block diagram illustrating an example architecture of a multi-product qualification analysis system that includes a logic subsystem and a feedback loop, in accordance with some examples;

FIG. 4 is a conceptual diagram illustrating a table of decisions, a table of logic, and an example of a user interface that provides an ordered list of recommendations for products, with the order of the list being based on one or more factors associated with the table of decisions and the table of logic, in accordance with some examples;

FIG. 5 is a block diagram illustrating an example architecture of a multi-product qualification analysis system that includes an offer engine that obtains information from various data sources and uses the information to pull various levers based on various considerations, in accordance with some examples;

FIG. 6 is a block diagram illustrating an example of a machine learning (ML) system for training and use of one or more machine learning model(s) used to generate one or more decision(s) on whether a user is qualified for a given product, and/or to generate ranking(s) indicating an order in which to arrange a list of recommendations for products that a user is qualified for, in accordance with some examples;

FIG. 7 is a conceptual diagram illustrating a process for dynamically updating a machine learning model in a continuous fashion as further data continues to be received over time, in accordance with some examples;

FIG. 8 is a flow diagram illustrating a process for qualification analysis, in accordance with some examples; and

FIG. 9 is a diagram illustrating an example of a computing system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

A qualification system can analyze information about a user and identify whether the user qualifies for a specific product, such as a credit card or a loan. In some examples, multiple products might be able to serve a user's needs. For instance, a credit card or a loan could both assist a user seeking to make a large purchase. Furthermore, in some examples, different qualification systems (that determine whether a user qualifies for different products) can rely on the same types of user information. However, traditionally, different products have different qualification systems, with each operating separately. If a user wants to know whether they qualify for multiple different types of products, the user may need to submit the same information through multiple different qualification systems. In some examples, a qualification system may retrieve credit score(s) from credit scoring agencies, and may use the credit score(s) as part of making a qualification decision.

Systems and techniques are described for qualification analysis and decisioning for multiple products at a time. In some examples, a system receives user information that is indicative of a user's income stream and/or asset(s). The system receives product qualification criteria data corresponding to products, with different products corresponding to different product-specific qualification criteria. The product qualification criteria data can change over time. The system dynamically analyzes the user information and the product qualification criteria data using a trained machine learning (ML) model in real-time as the user information and the product qualification criteria data continue to be received. The trained ML model identifies a subset of the plurality of products that the user qualifies for at a specific time. The system outputs recommendations for the subset of the plurality of products. In some examples, the system ranks the subset of the plurality of products to generate a ranking of the subset of the plurality of products. For instance, in some examples, the system generates the ranking using a second trained ML model, for instance based on the user information and the product qualification criteria data. In some examples, the system outputs the recommendations for the subset of the plurality of products as an ordered list that is ordered according to the ranking of the subset of the plurality of products. In some examples, the system dynamically trains the trained ML model and/or the second trained ML model further (e.g., using the recommendations, the user information, and/or the ranking as training data), for instance to update the trained ML model for future qualification decisions and/or the update the second trained ML model for future recommendation ranking decisions.

The automated qualification analysis and decisioning systems and techniques described herein provide a number of technical improvements over other qualification systems. For instance, the qualification analysis and decisioning systems and techniques described herein allow a single set of user information to be used to generate qualification decisions for multiple products, increasing efficiency, reducing power usage (e.g., battery drain), reducing heat generation, and reducing need for heat dissipation component usage (e.g., fans, heat sinks). Use of a single set of user information to generate qualification decisions for multiple products by the systems and techniques described herein can also reduce bandwidth usage, network resource usage, and computational network usage, as certain types of user information that are retrieved from an external data source (e.g., such as credit scores from a credit bureau) need only be retrieved once for multiple qualification decisions for multiple products, rather than multiple times (e.g., once per product). The automated qualification analysis and decisioning systems and techniques described herein further provide improved user interface(s) for computing devices that are more efficient than interfaces of other qualification systems, for instance by providing a list of products that a user qualifies for (e.g., in some examples, an ordered list of the products ranked by according to factor(s) such as how well each product suits the user's needs) all in a single interface that the user can select from to immediately proceed with onboarding for the selected product. This improves over separate qualification systems that force a user to perform multiple separate qualification analyses in separate interfaces, with no ability to compare between products or know which product might be better for the user than another product.

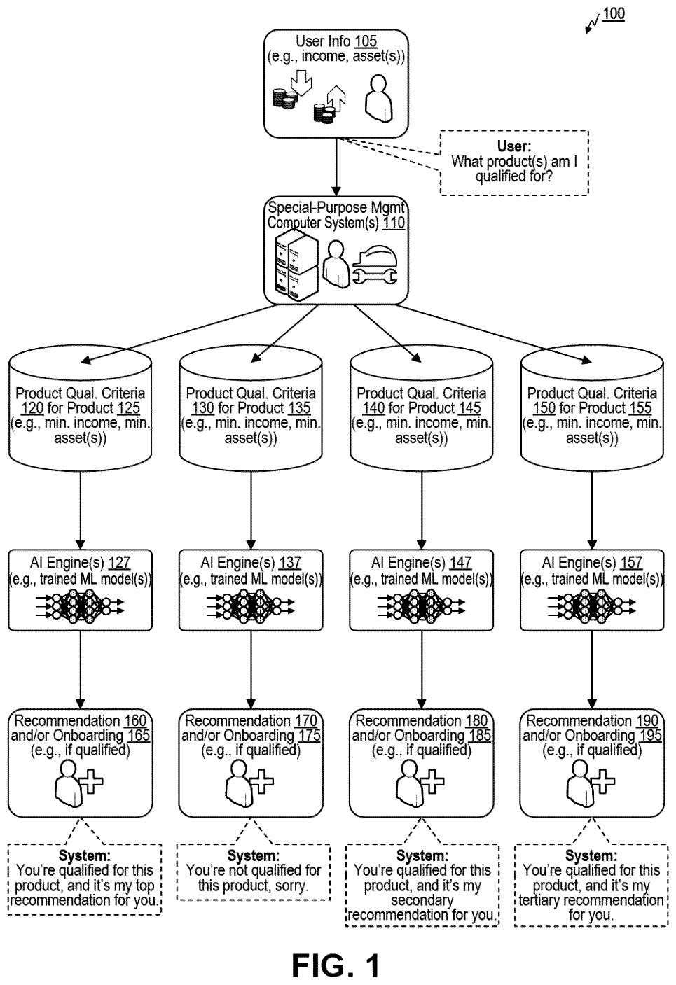

Various aspects of the application will be described with respect to the figures. FIG. 1 is a block diagram illustrating an example architecture of a multi-product qualification analysis system 100 that analyzes a single set of user information 105 based on multiple sets of product qualification criteria (e.g., product qualification criteria 120, product qualification criteria 130, product qualification criteria 140, product qualification criteria 150) to determine eligibility of a user for multiple different products (e.g., product 125, product 135, product 145, product 155). The multi-product qualification analysis system 100 includes one or more special-purpose management computer system(s) 110 that receives user information 105 from one or more data sources. The user information 105 can include information about one or more users. In some examples, the user information 105 includes information about a specific user. The user information 105 can include user-specific information such as a name of a user, a mailing address of the user, a billing address of the user, an address of the user, a birth date of the user, an area (e.g., location coordinates, address, city, county, country, continent, region) of birth of the user, a home phone number of the user, an office phone number of the user, a cell phone number of the user, a phone number of the user, a location (e.g., location coordinates, address, city, county, country, continent, region, area) of the user (and/or of a user device of the user), a social security number (SSN) of the user, an individual taxpayer identification number (ITIN) of the user, a taxpayer identification number (TIN) of the user, a government-issued identification number of the user, an employer of the user, a race of the user, an ethnicity of the user, a gender of the user, a sex of the user, a height of the user, a weight of the user, an immigration status of the user, one or more political view(s) of the user, other demographic information associated with the user, other information associated with the user, or a combination thereof. It should be understood that the types of user information 105 that are obtained and/or used by the management computer system(s) 110 can be limited to comply with laws, privacy practices, user preferences, or combinations thereof. Any of the types of user information 105 identified above can be omitted based on laws, privacy practices, user preferences, or combinations thereof.

In some examples, the management computer system(s) 110 can receive at least some of the user information 105 from a user interface (UI), such as a graphical user interface (GUI), at a user device associated with the user. For instance, the UI of the user device can receive portion(s) of the user information 105 that are input (e.g., typed, selected, and/or otherwise identified) by the user, and the user device can provide these portion(s) of the user information 105 to the management computer system(s) 110. In some examples, the management computer system(s) 110 can receive at least some of the user information 105 from one or more external data sources, such as one or more database(s), server(s), data structure(s), or combinations thereof. The external data source(s) can be associated with one or more government(s), financial institution(s), credit bureau(s), bank(s), credit card companie(s), merchant(s), payment service(s), or combinations thereof. In some examples, the management computer system(s) 110 can receive a first portion of the user information 105 through a UI of the user device, can query external data source(s) using the first portion of the user information 105, and can receive a second portion of the user information 105 from the external data source(s) in response to the query. For instance, in an illustrative example, the management computer system(s) 110 can receive an SSN of the user from the user device (e.g., the SSN having been received by the UI of the user device), can query external data source(s) for other information about the user using the SSN of the user, and can retrieve the other information about the user (e.g., name, address, date of birth, phone number, etc.) from the external data source(s) based on the query.

The multi-product qualification analysis system 100 stores multiple sets of product qualification criteria (e.g., product qualification criteria 120, product qualification criteria 130, product qualification criteria 140, product qualification criteria 150) for multiple different products (e.g., product 125, product 135, product 145, product 155). In some examples, the multi-product qualification analysis system 100 includes one or more artificial intelligence (AI) engine(s) that the management computer system(s) 110 uses to compare the user information 105 to the various product qualification criteria (e.g., product qualification criteria 120, product qualification criteria 130, product qualification criteria 140, product qualification criteria 150) to identify whether the user (e.g., who is associated with the user information 105) qualifies for each of the products (e.g., product 125, product 135, product 145, product 155). The one or more AI engine(s) can include AI engine(s) 127 that the management computer system(s) 110 to compare the user information 105 to product qualification criteria 120 associated with a product 125 to identify whether the user (e.g., who is associated with the user information 105) qualifies for the product 125. The one or more AI engine(s) can include AI engine(s) 137 that the management computer system(s) 110 to compare the user information 105 to product qualification criteria 130 associated with a product 135 to identify whether the user (e.g., who is associated with the user information 105) qualifies for the product 135. The one or more AI engine(s) can include AI engine(s) 147 that the management computer system(s) 110 to compare the user information 105 to product qualification criteria 140 associated with a product 145 to identify whether the user (e.g., who is associated with the user information 105) qualifies for the product 145. The one or more AI engine(s) can include AI engine(s) 157 that the management computer system(s) 110 to compare the user information 105 to product qualification criteria 150 associated with a product 155 to identify whether the user (e.g., who is associated with the user information 105) qualifies for the product 155.

In In some examples, the one or more AI engine(s) (e.g., AI engine(s) 127, AI engine(s) 137, AI engine(s) 147, AI engine(s) 157) are each separate AI system(s), for instance separate machine learning (ML) model(s). In some examples, two or more of the AI engine(s) (e.g., AI engine(s) 127, AI engine(s) 137, AI engine(s) 147, AI engine(s) 157) share at least one element, for instance sharing one or more ML model(s) used by each.

The multi-product qualification analysis system 100 (e.g., the management computer system(s) 110 and/or the AI engine(s)) can generate recommendation(s) for the products that the user is qualified for, for instance including a recommendation 160 for the product 125, a recommendation 170 for the product 135, a recommendation 180 for the product 145, and/or a recommendation 190 for the product 155. The recommendation for a specific product can include UI element(s) (e.g., button(s), switch(es), slider(s), checkbox(es), radio button(s), other UI element(s), or combination(s) thereof) that trigger onboarding of the user onto the specific product, for instance to sign the user up for the specific product, to present further information (e.g., terms and conditions) and/or form(s) for the user related to initiating the specific product for the user, to register the user in a database or other data structure associated with the specific product, other onboarding operation(s), or combinations thereof. For instance, the recommendation 160 for the product 125 can include a UI element to initiate onboarding 165 of the user onto the product 125, the recommendation 170 for the product 135 can include a UI element to initiate onboarding 175 of the user onto the product 135, the recommendation 180 for the product 145 can include a UI element to initiate onboarding 185 of the user onto the product 145, and the recommendation 190 for the product 155 can include a UI element to initiate onboarding 195 of the user onto the product 155.

In some examples, the multi-product qualification analysis system 100 (e.g., the management computer system(s) 110 and/or the AI engine(s)) can generate the recommendation(s) (e.g., the recommendation 160, the recommendation 170, the recommendation 180, and/or the recommendation 190) dynamically and in real-time as the user information 105 and/or the product qualification criteria (e.g., product qualification criteria 120, product qualification criteria 130, product qualification criteria 140, product qualification criteria 150) continue to be received by the multi-product qualification analysis system 100. For instance, elements of user information 105, such as tracked transactions in a transaction history associated with the user, can continue to come in over time, and the multi-product qualification analysis system 100 can rapidly accommodate to the changes in the user information 105 to ensure that up-to-date user information 105 is used in determining what the user is qualified for and/or in generating the recommendations. Similarly, the product qualification criteria can undergo changes overt time, and the multi-product qualification analysis system 100 can rapidly accommodate to the changes in the product qualification criteria to ensure up-to-date product qualification criteria are used in determining what the user is qualified for and/or in generating the recommendations.

In some examples, the AI engine(s) that the management computer system(s) 110 uses to compare the user information 105 to the various product qualification criteria (e.g., product qualification criteria 120, product qualification criteria 130, product qualification criteria 140, product qualification criteria 150) also use this comparison to rank the various products (e.g., product 125, product 135, product 145, product 155) based on various factors. The factors can include, for instance, a level of suitability of the user's needs (e.g., how well the product suits the user's needs), amount that the product allows a user to spend (e.g., credit limit, loan amount), amount of interest to be incurred through use of the product (e.g., total and/or across a specific period of time), user preference(s) as to types of products (e.g., user prefers credit cards over installment loans or vice versa), merchant preference(s) as to types of products (e.g., merchant prefers that purchases be made using installment loans over credit cards or vice versa), of level of adherence to a specific rule or set of rules, another factor, or a combination thereof. Once the AI engine(s) rank the products that the user is qualified for to generate a ranking of the products that the user is qualified for, the multi-product qualification analysis system 100 (e.g., the management computer system(s) 110 and/or the AI engine(s)) present the recommendation(s) for the product(s) (e.g., the recommendation 160 for the product 125, the recommendation 170 for the product 135, the recommendation 180 for the product 145, and/or the recommendation 190 for the product 155) in an ordered list that is ordered according to the ranking of the products.

In some examples, the products may include secured credit card(s), unsecured credit card(s), private label credit card(s) (PLCC(s)), annual percentage rate (APR) credit card(s), business credit card(s), personal credit card(s), charge cards, installment loan(s), personal loan(s) on credit card(s) (PLCC(s)), healthcare loan(s), pet care loan(s), mortgage(s), student loan(s), debt consolidation loan(s), cash advance(s), home equity loan(s), payday loan(s), secured personal loan(s), unsecured personal loan(s), revolving line(s) of credit, line(s) of credit, title loan(s), credit card loan(s), small business loan(s), credit builder loan(s), “pay later” loans, financial product(s), or combinations thereof.

In an illustrative example, a user may submit a request to the multi-product qualification analysis system 100 (e.g., to the management computer system(s) 110) to ask which product(s) the user is qualified for, based on the user information 105. The request is represented in FIG. 1 by a callout box with dashed lines reading “User: What product(s) am I qualified for?” The multi-product qualification analysis system 100 (e.g., the management computer system(s) 110 and/or the AI engine(s)) can compare the user information 105 to the various product qualification criteria (e.g., product qualification criteria 120, product qualification criteria 130, product qualification criteria 140, product qualification criteria 150) for the various products (e.g., product 125, product 135, product 145, product 155) to generate recommendations (e.g., recommendation 160, recommendation 170, recommendation 180, recommendation 190) for the various products. The recommendations may be ordered according to a ranking of the products by the multi-product qualification analysis system 100 (e.g., the management computer system(s) 110 and/or the AI engine(s)) according to various factors discussed herein. The recommendations may have UI elements for onboarding (e.g., onboarding 165, onboarding 175, onboarding 185, onboarding 195), at least for the products that the user is qualified for. The recommendation 160 is represented in FIG. 1 by a callout box with dashed lines reading “System: You're qualified for this product, and it's my top recommendation for you,” indicating that the user is qualified for the product 125, and that the multi-product qualification analysis system 100 ranks the product 125 most highly for the user. The recommendation 160 may include a button or other UI element to initiate onboarding 165 of the user onto the product 125. The recommendation 170 is represented in FIG. 1 by a callout box with dashed lines reading “System: You're not qualified for this product, sorry,” indicating that the user is not qualified for the product 135. The recommendation 180 is represented in FIG. 1 by a callout box with dashed lines reading “System: You're qualified for this product, and it's my secondary recommendation for you,” indicating that the user is qualified for the product 145, and that the multi-product qualification analysis system 100 ranks the product 145 in second place for the user, after the product 125. The recommendation 180 may include a button or other UI element to initiate onboarding 185 of the user onto the product 145. The recommendation 190 is represented in FIG. 1 by a callout box with dashed lines reading “System: You're qualified for this product, and it's my tertiary recommendation for you,” indicating that the user is qualified for the product 155, and that the multi-product qualification analysis system 100 ranks the product 155 in third place for the user, after the product 125 and the product 145. The recommendation 190 may include a button or other UI element to initiate onboarding 195 of the user onto the product 155.

The AI engines (e.g., AI engine(s) 122, AI engine(s) 132, AI engine(s) 142, and/or AI engine(s) 152) can include, for instance, one or more neural network (NN(s)), convolutional NN(s) (CNN(s)), trained time delay NN(s) (TDNN(s)), deep network(s), autoencoder(s) (AE(s)), variational AE(s) (VAE(s)), deep belief net(s) (DBN(s)), recurrent NN(s) (RNN(s)), generative adversarial network(s) (GAN(s)), conditional GAN(s) (cGAN(s)), support vector machine(s) (SVM(s)), random forest(s) (RF(s)), decision tree(s), NN(s) with fully connected (FC) layer(s), NN(s) with convolutional layer(s), computer vision system(s), deep learning system(s), classifier(s), transformer(s), clustering algorithm(s), reinforcement learning model(s), supervised learning model(s), unsupervised learning model(s), gradient boosting model(s), sequence-to-sequence (Seq2Seq) model(s), autoregressive (AR) model(s), large language model(s) (LLMs), or combinations thereof. Examples of LLMs that can be used can include, for instance, a Generative Pre-Trained Transformer (GPT) (e.g., GPT-2, GPT-3, GPT-3.5, GPT-4, and/or other GPT variant(s)). DaVinci, an LLM using Massachusetts Institute of Technology (MIT) langchain, Google® Bard®, Google® Gemini®, Large Language Model Meta AI (LLaMA), another LLM, or a combination thereof.

Within FIG. 1, a graphic representing the various AI engines (e.g., AI engine(s) 127, AI engine(s) 137, AI engine(s) 147, and/or AI engine(s) 157) illustrates a set of circles connected to another. Each of the circles can represent a node, a neuron, a perceptron, a layer, a portion thereof, or a combination thereof, for instance of a NN or other ML model. The circles are arranged in columns. The leftmost column of white circles represent an input layer. The rightmost column of white circles represent an output layer. Two columns of shaded circled between the leftmost column of white circles and the rightmost column of white circles each represent hidden layers. The lines between nodes can represent weights between nodes. Weights can be added, removed, strengthened, weakened, or otherwise updated as the AI engines are updated or further trained based on new training data.

In some examples, the product qualification criteria (e.g., product qualification criteria 120, product qualification criteria 130, product qualification criteria 140, product qualification criteria 150) can be stored in one or more data store(s), which can include, for instance, database(s), table(s), spreadsheet(s), list(s), array(s), arraylist(s), heap(s), tree(s), dictionar(ies), linked list(s), hash table(s), graph(s), stack(s), queue(s), trie(s), queap(s), distributed ledger(s), blockchain ledger(s), directed acyclic graph(s) (DAGs), data model(s), record(s), linked data structure(s), other data structure(s), or combination(s) thereof. In some examples, at least some of the user information 105 can be stored in any of the types of data store(s) discussed herein.

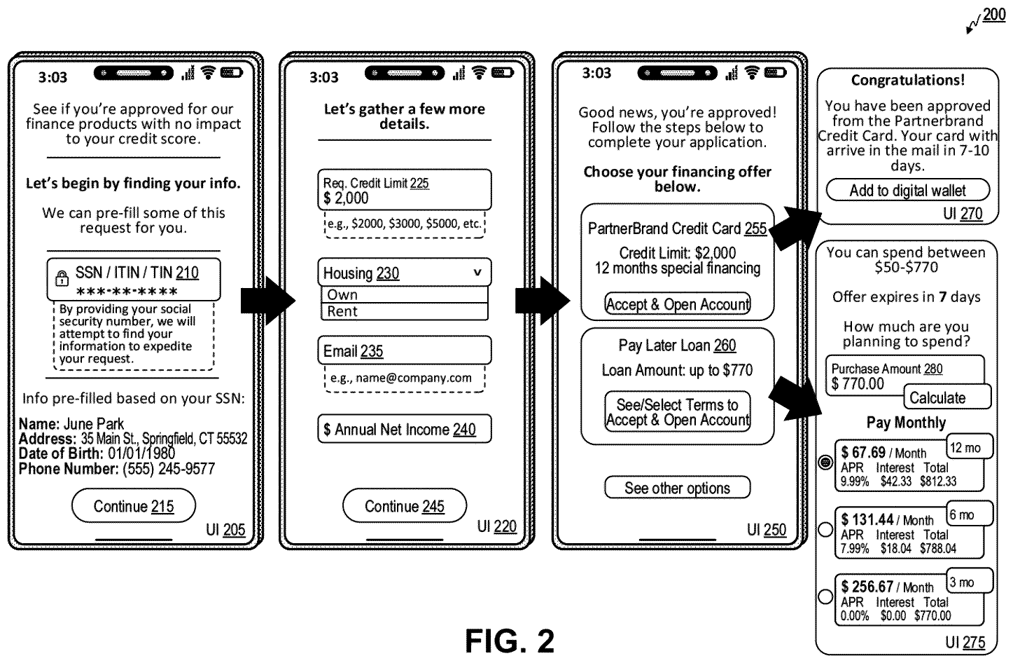

FIG. 2 is a conceptual diagram 200 illustrating examples of user interfaces (e.g., user interface 205, user interface 220, user interface 250, user interface 270, user interface 275) for obtaining user information 105 associated with a user and providing an ordered list of recommendations for products that the user is qualified for, with the order of the list being based on one or more factors. The user interfaces are presented on a user device, illustrated as a mobile device (e.g., a phone, a tablet, a mobile handset, a portable game console, a portable media player device, a wearable device, a laptop, a desktop computer). In some examples, the user device can be a different type of device, such as a point of sale (POS) terminal, a card reader device, a payment instrument reader device, a server, or a combination thereof.

The user device (UI) 205 includes messages reading “see if you're approved for our finance products with no impact to your credit score,” “let's begin by finding your info,” and “we can pre-fill some of this request for you.” The UI 205 includes a field 210 that requests that the user input an SSN of the user, an ITIN of the user, and/or a TIN of the user. The field 210 may be secured as indicated by the lock icon on the field 210, for instance indicating that the contents of the field will be encrypted before being transmitted further (e.g., to the management computer system(s) 110 and/or the AI engine(s) of FIG. 1), and/or that the contents of the field can be obscured (e.g., showing up in the UI 205 as a series of asterisks or other symbols rather than the actual characters entered by the user). For instance, the field 210 is illustrated in FIG. 2 as filled in with “***-**-****,” which can represent an obscured variant of the SSN, ITIN, or TIN of the user. The UI 205 automatically pre-fills additional information about the user based on the information that the user enters into the field 210 (e.g., the user's SSN, ITIN, and/or TIN). For instance, the additional information that the UI 205 automatically pre-fills includes the name of the user (e.g., identified in FIG. 2 as “June Park”), the address of the user (e.g., identified in FIG. 2 as “35 Main St., Springfield, CT 55532”), the date of birth of the user (e.g., identified in FIG. 2 as Jan. 1, 1980), and the phone number of the user (e.g., identified in FIG. 2 as (555) 245-9577). In some examples, the UI 205 receives the additional information that the UI 205 pre-fills by querying external source(s) (e.g., database(s)) using the information that the user enters into the field 210 (e.g., the user's SSN, ITIN, and/or TIN). In some examples, the UI 205 may include a button or other UI element that allows the user to edit any of the additional information that the UI 205 automatically pre-fills, for instance if the name, address, date of birth, or phone number includes error(s) and/or inaccuracie(s). The information that the user enters into the field 210 (e.g., the user's SSN, ITIN, and/or TIN) and the additional information pre-filled by the UI 205 can all be considered portion(s) of the user information 105. A continue button 215 allows the user device to proceed from the UI 205 to the UI 220.

The UI 220 includes a message reading “let's gather a few more details,” and includes fields for collecting further user information (e.g., of the user information 105). For instance, the UI 220 includes a field 225 for identifying the user's requested credit limit. For instance, the user can identify, in the field 225, that the user would like a product with a credit limit (e.g., spend amount) of at least $2,000, at least $3,000, at least $5,000, at least $10,000, or another amount. The field 225 is illustrated in FIG. 2 as being filled in with a value of $2,000, as an illustrative example. The UI 220 includes a field 230 for identifying whether the user owns or rents their housing, which may impact the user's eligibility for certain products (e.g., product(s) that use a user's owned housing as collateral). The UI 220 includes a field 235 for identifying the user's email address, which the multi-product qualification analysis system 100 (e.g., the management computer system(s) 110) may in some cases use to send the recommendation(s) (e.g., recommendation 160, recommendation 170, recommendation 180, recommendation 190), information associated with product onboarding (e.g., onboarding 165, onboarding 175, onboarding 185, onboarding 195), and/or other notification(s) or alert(s) to. A continue button 245 allows the user device to proceed from the UI 222 to the UI 250.

The UI 250 includes a message reading “good news, you're approved!” The UI 250 also includes messages reading “follow the steps below to complete your application” and “choose your financing offer below.” The UI 250 includes an ordered list of recommendations for two products that the user is approved for, including a PartnerBrand Credit Card 255 (with a credit limit of $2,000 and with 12 months of special financing) and a Pay Later Loan 260 (with a loan amount of up to $870). In some examples, the PartnerBrand Credit Card 255 may be ranked higher than the Pay Later Loan 260 in the UI 250 because the credit limit of the PartnerBrand Credit Card 255 ($2,000) is higher than the maximum loan amount of the Pay Later Loan 260 ($870). In fact, the credit limit of the PartnerBrand Credit Card 255 ($2,000) matches the requested credit limit filled into field 225 (also $2,000), making the PartnerBrand Credit Card 255 most suitable for the user's needs according to the user information 105 (e.g., according to the requested credit limit filled into field 225). The recommendation for the PartnerBrand Credit Card 255 includes a button with a message “accept & open account,” which can initiate onboarding of the user to the PartnerBrand Credit Card 255 product, and can transfer the user device from the UI 250 to the UI 270. The recommendation for the Pay Later Loan 260 includes a button with a message “see/select terms to accept & open account,” which can initiate onboarding of the user to the Pay Later Loan 260 product, and can transfer the user device from the UI 250 to the UI 275. The UI 250 also includes a “see other options” button that, in some examples, may show the user additional product(s) that the user qualifies for, but that are not recommended for the user (e.g., by the multi-product qualification analysis system 100), for instance because the additional product(s) are not suitable for the user's needs, the additional products have lower spend amount(s) than the recommended products, the additional product(s) go against the user's own stated preferences (e.g., not to use their home as collateral, for instance), and/or based on other factor(s).

The UI 270 includes messages reading “congratulations,” “you have been approved from the Partnerbrand Credit Card,” and “your card with arrive in the mail in 7-10 days.” The UI 270 also includes a button with a message reading “add to digital wallet,” which, if pressed by the user, can allow the Partnerbrand Credit Card to be added to a digital wallet (e.g., Apple® wallet, Google® wallet/pay, Samsung® pay, or another digital wallet service) so that the user can start using the Partnerbrand Credit Card immediately without having to wait for the physical card associated with the Partnerbrand Credit Card to arrive in the mail.

The UI 275 includes messages reading “you can spend between $50-$870,” indicating how much spending the Pay Later Loan 260 can cover, and “offer expires in 7 days,” indicating that the user must decide whether to onboard onto the Pay Later Loan 260 product within 7 days or the offer to onboard onto the Pay Later Loan 260 product expires. The UI 275 includes a field 280 requesting a purchase amount, with a message asking “how much are you planning to spend?” The field 280 is illustrated in FIG. 2 as being filled in with a value of $870, as an illustrative example. A “calculate” button next to the field 280 causes different selectable options for installment payment schedules to appear under a message reading “pay monthly.” The different selectable options for installment payment schedules includes a first option for a 12-month installment loan at $67.69 per month, with 9.99% APR, $42.33 of total interest to be paid, and $912.33 total amount to be paid. The different selectable options for installment payment schedules includes a second option for a 6-month installment loan at $131.44 per month, with 7.99% APR, $18.04 of total interest to be paid, and $888.04 total amount to be paid. The different selectable options for installment payment schedules includes a third option for a 3-month installment loan at $256.67 per month, with 0.00% APR, $0.00 of total interest to be paid, and $870.00 total amount to be paid. The UI 275 as illustrated in FIG. 2 illustrates the first option for the first installment payment schedule being selected via radio button, as an illustrative example. Selection of this installment payment schedule option can initiate onboarding of the user onto the Pay Later Loan 260 product using the selected installment payment schedule option.

In some examples, at least one of the recommendations for offers for products presented in the UI 250 (e.g., for the PartnerBrand Credit Card 255 product or for the Pay Later Loan 260 product) can be recalled from a previous round of decisioning, for instance being a previous offer that was previously offered to the user and is still valid. For instance, in an illustrative example, the user can have submitted a request for multi-product qualification analysis five days prior to the generation of the UI 250, and one of the offers from that previous multi-product qualification analysis can be the offer for the Pay Later Loan 260. Because the offer for the Pay Later Loan 260 is valid for 7 days, the offer for the Pay Later Loan 260 is still valid for the current multi-product qualification analysis. Thus, the previous offer for the Pay Later Loan 260 that is still valid can be included into the UI 250, without having to create a new offer.

In some examples, the multi-product qualification analysis system 100 (e.g., the management computer system(s) 110 and/or the AI engine(s)) can make decisions (e.g., that the user is qualified for the PartnerBrand Credit Card 255 product and for the Pay Later Loan 260 product) dynamically and in real-time as user information and/or the product qualification criteria continue to be received and/or modified. For instance, elements of user information can still be in gradually retrieved, as in the pre-filled content of UI 205 that may be queried based on content provided in the various fields of the UIs of FIG. 2, to ensure that up-to-date user information is used in determining what the user is qualified for and/or in generating the recommendations.

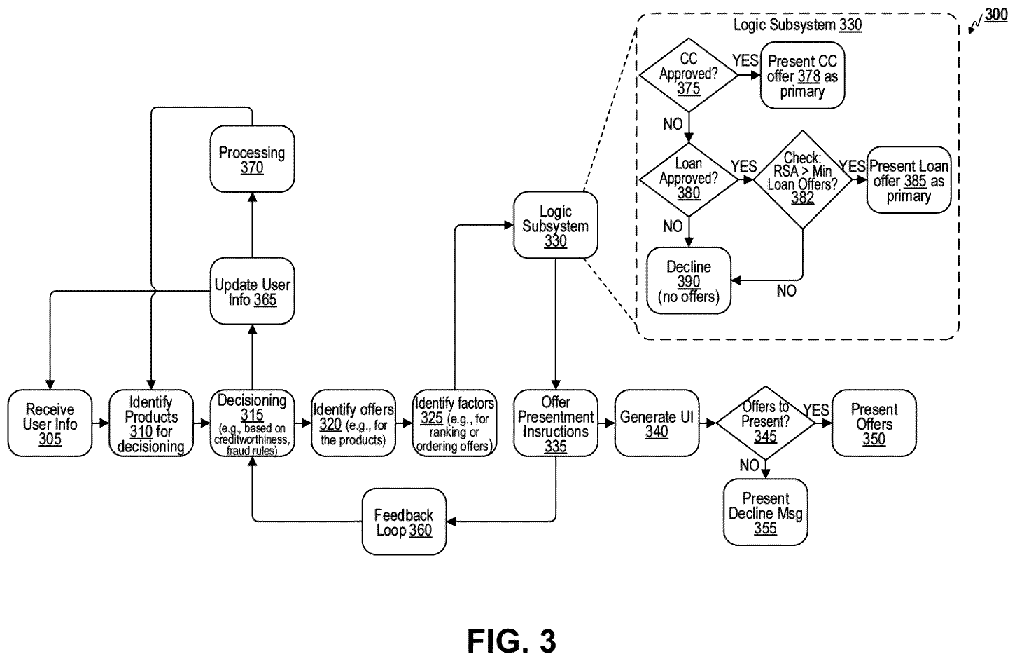

FIG. 3 is a block diagram illustrating an example architecture of a multi-product qualification analysis system 300 that includes a logic subsystem 330 and a feedback loop 360. The multi-product qualification analysis system 300 performs a process for multi-product qualification analysis. The multi-product qualification analysis system 300 first receives user information 305, for instance as part of a request from a user for qualification decision(s) as to whether the user qualifies for various products. The user information 305 may be an example of the user information 105 and/or the user information of FIG. 2. The multi-product qualification analysis system 300 identifies products 310 about which qualification decisions should be made. For instance, the list of available products 310 (e.g., and/or offers available for those products) can update as time goes on, with different products 310 and/or offers being available at different times. For instance, in some examples, new products (e.g., and/or offers) can be newly added to the list of products 310 that are available. Similarly, in some examples, certain products (e.g., and/or offers) can be removed or discontinued from the list of products 310 that are available, and/or can be modified. The multi-product qualification analysis system 300 can retrieve product qualification criteria (e.g., product qualification criteria 120, product qualification criteria 130, product qualification criteria 140, product qualification criteria 150) for each of the products 310.

The multi-product qualification analysis system 300 performs decisioning 315 to identify which of the products 310 the user is qualified for, based on the user information 305, the respective product qualification criteria for each of the products 310, a creditworthiness analysis, fraud detection rules, additional considerations, or combinations thereof. For instance, in some examples, the product qualification criteria for a specific product can identify threshold(s) for creditworthiness for the specific product, and the multi-product qualification analysis system 300 can identify whether the user information 305 meets or exceeds the threshold(s) for creditworthiness for the specific product during the decisioning 315 to identify whether the user qualifies for the specific product. In some examples, the multi-product qualification analysis system 300 can analyze the user information 305 in light of fraud detection rules (e.g., the rules associated with the product qualification criteria and/or with the multi-product qualification analysis system 300 itself) to ensure that the probability of fraud is below a predetermined threshold (e.g., the threshold associated with the product qualification criteria and/or with the multi-product qualification analysis system 300 itself). In some examples, the decisioning 315 is performed using AI engine(s) and/or ML model(s) of the multi-product qualification analysis system 300.

Once the multi-product qualification analysis system 300 identifies the products that the user qualifies for during the decisioning 315, the multi-product qualification analysis system 300 can identify offers 320 associated with the products that the user qualifies for. The multi-product qualification analysis system 300 can also identify factors 325 to be used for ranking and/or ordering the offers 320 in a particular order. The factors 325 can include, for instance, a level of suitability of the user's needs (e.g., how well the product and/or offer suits the user's needs), amount that the product and/or offer allows a user to spend (e.g., credit limit, loan amount), amount of interest to be incurred through use of the product and/or offer (e.g., total and/or across a specific period of time), user preference(s) as to types of products and/or offers (e.g., user prefers credit cards over installment loans or vice versa), merchant preference(s) as to types of products and/or offers (e.g., merchant prefers that purchases be made using installment loans over credit cards or vice versa), of level of adherence to a specific rule or set of rules, another factor, or a combination thereof.

The multi-product qualification analysis system 300 includes a logic subsystem 330 that can make decisions as to how, and whether, to present certain offers (of the offers 320 for the subset of the products 310 that the user qualifies for) to the user through a UI 340 (e.g., UI 250) of a user device. The logic subsystem 330 generates offer presentment instructions 335 that are used by the multi-product qualification analysis system 300 to generate the UI 340. In some examples, the logic subsystem 330 can rank the offers to identify an order in which the offers are to be presented in the UI 340, for instance based on the factors 325. This ranking can be included in the offer presentment instructions 335 generated by the logic subsystem 330, so that the offers are presented in the UI 340 ordered according to the ranking. In some examples, logic subsystem 330 can remove specific offer(s) from the UI, for instance if the logic subsystem 330 determines that the specific offer(s) do not meet the user's needs (e.g., provide insufficient credit for the user to spend), and/or that the specific offer(s) fail to meet another threshold related to another one of the factor(s) 325. In some examples, such removals can be included in the offer presentment instructions 335 generated by the logic subsystem 330, so that the offers that are presented in the UI 340 omit the specific offer(s) that are to be removed. Ultimately, if offer presentment instructions 335 that are generated by the logic subsystem 330 indicate that there are offers to present (at decision 345), then the multi-product qualification analysis system 300 causes the user device to present the offers 350 through the UI generated via the offer presentment instructions 335. On the other hand, if offer presentment instructions 335 that are generated by the logic subsystem 330 indicate that there are no offers to present (at decision 345), then the multi-product qualification analysis system 300 causes the user device to present a decline message 355 through the UI generated via the offer presentment instructions 335, indicating that the user is either not qualified for any offers, or that the multi-product qualification analysis system 300 does not recommend any offers to the user (e.g., the user might qualify for one or more offers but the multi-product qualification analysis system 300 has determined that they are not recommended for the user based on the factors 325).

In an illustrative example, the logic subsystem 330 can check if the user is approved for a credit card 375 according to the decisioning 315. If the user is approved for the credit card 375 (e.g., as determined in the decisioning 315), the logic subsystem 330 can determine that the credit card offer 378 for the credit card 375 is to be presented as a primary offer (e.g., highest-ranked offer) and therefore presented first (before any other offer) in the UI 340. If the user is not approved for the credit card 375 (e.g., as determined in the decisioning 315), the logic subsystem 330 can next check if the user is approved for a loan 380 according to the decisioning 315. If the user is approved for the loan 380 (e.g., as determined in the decisioning 315), and if a check 382 confirms that a requested sale amount (RSA) associated with the loan 380 has a value greater than a minimum loan offer amount for the loan 380, then the logic subsystem 330 can determine that the loan offer 385 for the loan 380 is to be presented as a primary offer (e.g., highest-ranked offer) and therefore presented first (before any other offer) in the UI 340. If the user is not approved for the loan 380 (e.g., as determined in the decisioning 315), or if the check 382 indicates that the RSA associated with the loan 380 does not have a value greater than the minimum loan offer amount for the loan 380, the logic subsystem 330 can decline 390 to present either the CC offer 378 or the loan offer 385.

In some examples, the multi-product qualification analysis system 300 includes a feedback loop 360 through which the offer presentment instructions 335 can be fed into the decisioning 315 engine. For instance, in some examples, if the logic subsystem 330 determines that certain offers are not appropriate for a user (e.g., based on at least a subset of the factors 325) and should not be included in the UI 340, then in future rounds of decisioning 315, the decisioning 315 engine can in some cases decide not to identify those offers for the user in the first place. In some examples, through the feedback loop 360, the multi-product qualification analysis system 300 can perform an update 365 of the user information 305 based on the offer presentment instructions 335. For instance, the user information 305 can be updated (via the update 365) to include indications of which products the user has previously qualified for, which products and/or offers have previously been recommended to the user, or a combination thereof. In some examples, the multi-product qualification analysis system 300 can perform additional processing 370 to update the product qualification criteria for the products 310, and/or to modify the products 310 themselves, based on the offer presentment instructions 335. For instance, in some examples, the processing 370 can include modifying the product qualification criteria for the products 310 to avoid identifying products for users that the products would not be a good fit for (e.g., based on at least a subset of the factors 325). In some examples, the processing 370 can include modifying the products 310 themselves (and/or associated offers 320) to be more suitable for more users (e.g., based on at least a subset of the factors 325).

In some examples, the multi-product qualification analysis system 300 (e.g., the decisioning 315 and/or the logic subsystem 330) can generate the decisions as to whether the user has qualified for the products 310, the offer presentment instructions 335, and/or the UI 340 dynamically and in real-time as the user information 305, the product qualification criteria associated with the products 310, the offers 320, and/or the factors 325 continue to be received and/or updated by the multi-product qualification analysis system 300. This can ensure that the decisions as to whether the user has qualified for the products 310, the offer presentment instructions 335, and/or the UI 340 are generated based on up-to-date user information 305, the product qualification criteria associated with the products 310, the offers 320, and/or the factors 325.

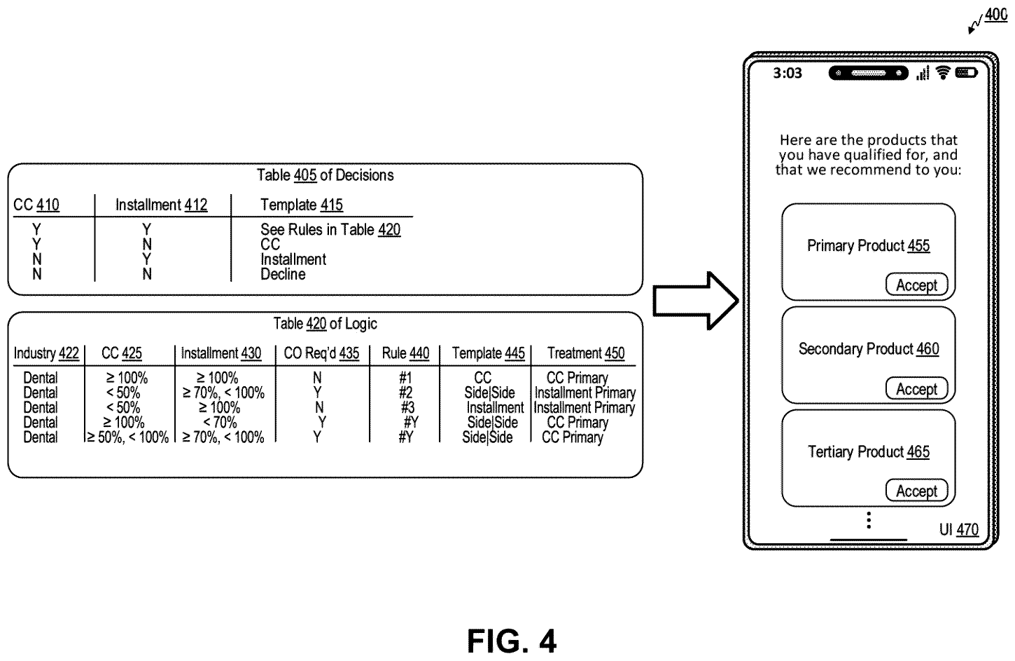

FIG. 4 is a conceptual diagram 400 illustrating a table 405 of decisions, a table 420 of logic, and an example of a user interface 470 that provides an ordered list of recommendations for products, with the order of the list being based on one or more factors associated with the table 405 of decisions and the table 420 of logic. The table 405 of decisions indicates that, if a user is determined (at decisioning 315) to be eligible for both a credit card 410 and an installment loan 412, then the template 415 for that user's offer(s) is determined by the table 420 of logic. The table 405 of decisions indicates that, if a user is determined (at decisioning 315) to be eligible for the credit card 410 but not the installment loan 412, then the template 415 for that user's offer(s) is a credit card offering template to offer the credit card 410. The table 405 of decisions indicates that, if a user is determined (at decisioning 315) to be eligible for the installment loan 412 but not the credit card 410, then the template 415 for that user's offer(s) is a installment loan offering template to offer the installment loan 412. The table 405 of decisions indicates that, if a user is determined (at decisioning 315) to be eligible for neither the credit card 410 nor the installment loan 412, then the template 415 for that user's offer(s) is a decline template to indicate that the user has been declined qualification for either product.

The table 420 of logic illustrates, an example in which a user requests to take out a $5000 loan for a dental procedure. The industry 422 is listed as dental. In a first rule (of the rules 440) in the first row of the table 420 of logic, the credit card coverage 425 indicates that the credit card 410 covers greater than or equal to 100% of the user's needs, the installment loan coverage 430 indicates that the installment loan 412 covers greater than or equal to 100% of the user's needs, a counter-offer 435 is not required, a template 445 for the UI is a credit card template with a treatment 450 indicating that the credit card should be provided as the primary product ranked above any other product(s) (e.g., because, in some examples, users and/or merchants may generally prefer credit cards over installment loans, all else being equal). In a second rule (of the rules 440) in the second row of the table 420 of logic, the credit card coverage 425 indicates that the credit card 410 covers less than 50% of the user's needs, the installment loan coverage 430 indicates that the installment loan 412 covers 70% to 100% of the user's needs, a counter-offer 435 is required, a template 445 for the UI is a side-to-side template with a treatment 450 indicating that the installment loan should be provided as the primary product ranked above any other product(s) (e.g., because the installment loan here covers more of the user's needs than the credit card). In a third rule (of the rules 440) in the third row of the table 420 of logic, the credit card coverage 425 indicates that the credit card 410 covers less than 50% of the user's needs, the installment loan coverage 430 indicates that the installment loan 412 covers greater than or equal to 100% of the user's needs, a counter-offer 435 is not required, a template 445 for the UI is an installment loan template with a treatment 450 indicating that the installment loan should be provided as the primary product ranked above any other product(s) (e.g., because the installment loan here covers more of the user's needs than the credit card). In a fourth rule (of the rules 440) in the fourth row of the table 420 of logic, the credit card coverage 425 indicates that the credit card 410 covers greater than or equal to 100% of the user's needs, the installment loan coverage 430 indicates that the installment loan 412 covers only up to 70% of the user's needs, a counter-offer 435 is required, a template 445 for the UI is a side-to-side template with a treatment 450 indicating that the credit card should be provided as the primary product ranked above any other product(s) (e.g., because the credit card here covers more of the user's needs than the installment loan). In a fifth rule (of the rules 440) in the fifth row of the table 420 of logic, the credit card coverage 425 indicates that the credit card 410 covers 50% to 100% of the user's needs, the installment loan coverage 430 indicates that the installment loan 412 covers 70% to 100% of the user's needs, a counter-offer 435 is required, a template 445 for the UI is a side-to-side template with a treatment 450 indicating that the credit card should be provided as the primary product ranked above any other product(s) (e.g., because, in some examples, users and/or merchants may generally prefer credit cards over installment loans, all else being equal).

An example user interface (UI) 470 is illustrated. The UI 470 is displayed on a user device (e.g., a mobile handset), and includes a message reading “here are the products that you have qualified for, and that we recommend to you.” The UI 470 lists a primary product 455 (with an accept button that allows a user to onboard onto the primary product 455), a secondary product 460 (with an accept button that allows a user to onboard onto the secondary product 460), and a tertiary product 465 (with an accept button that allows a user to onboard onto the tertiary product 465). An ellipsis at the bottom of the UI 470 indicates that more products may also be listed after the tertiary product 465. In some examples, the primary product 455 may be the credit card 410, the installment loan 412, or another product. In some examples, different variations on a product may be listed as different products in the UI 470. For instance, in reference to the UI 275, the 12-month installment loan variant of a loan may be listed as a first product in the in the UI 470, the 6-month installment loan variant of the loan may be listed as a second product in the in the UI 470, the 3-month installment loan variant of the loan may be listed as a third product in the in the UI 470, and so forth.

In some examples, the template 445 being the side-to-side template as referenced in the table 420 of logic refers to a UI that displays multiple products that the user can select from, as in the UI 470 or the UI 250. In some examples, the template 445 being the credit card template may indicate that the credit card 410 is the primary product 455. In some examples, the template 445 being the credit card template may indicate that the credit card 410 is not only the primary product 455, but the only product in the UI 470, with the secondary product 460 and tertiary product 465 missing from the UI 470. In some examples, the template 445 being the installment loan template may indicate that the installment loan 412 is the primary product 455. In some examples, the template 445 being the installment loan template may indicate that the installment loan 412 is not only the primary product 455, but the only product in the UI 470, with the secondary product 460 and tertiary product 465 missing from the UI 470.

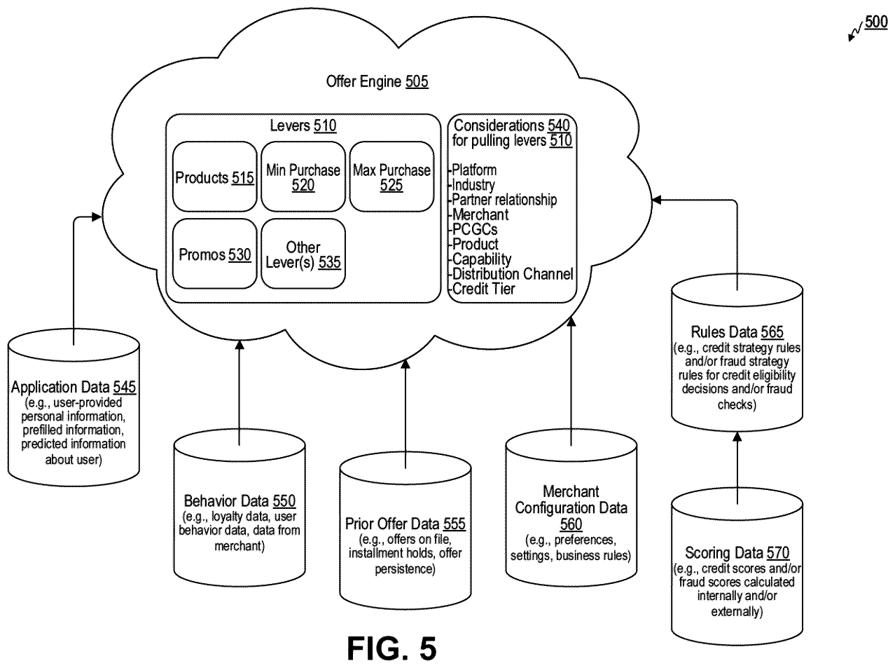

FIG. 5 is a block diagram illustrating an example architecture of a multi-product qualification analysis system 500 that includes an offer engine 505 that obtains information from various data sources and uses the information to pull various levers 510 based on various considerations 540. The offer engine 505 can serve as a model that is built on the various data from the data sources and that can be modified dynamically as the data is coming in. The model can be used to guide decisioning (e.g., decisioning 315), for instance with respect to which product(s) a user is qualified for or not, as well as a ranking or order in which product(s) (and/or associated offer(s)) are to be presented to a given user. The levers 510 represent aspects of the model that can be modified to adjust decisioning, with “pulling” a specific lever referring to modifying that aspect of the model in the offer engine 505. The levers 510 that the offer engine 505 can pull include the products 515 (e.g., which products are offered), a minimum purchase 520 threshold (e.g., a minimum loan and/or spend amount), a maximum purchase 525 threshold (e.g., a maximum loan and/or spend amount), one or more promotions 530 (e.g., discount(s), coupon(s), loyalty program(s), sale(s), bundle(s), giveaway(s), buy-one-get-one (BOGO) offer(s), free gift(s), competition(s), or combination(s) thereof), one or more other lever(s) 535, or combination(s) thereof. The offer engine 505 can pull lever(s) of the levers 510 based on various considerations 540, including platform, industry, partner relationship, merchant, product code-group codes (PCGCs), products, capabilities, distribution channels, credit tiers, other considerations, or combinations thereof.

The data sources that the offer engine 505 can build and/or modify the model based on, and/or that the model associated with the offer engine 505 can make decisions based on, include application data 545 data store(s), behavior data 550 data store(s), prior offer data 555 data store(s), merchant configuration data 560 data store(s), rules data 565 data store(s), and/or scoring data 570 data store(s). The application data 545 in the application data 545 data store(s) can include user-provided personal information (e.g., personal identifying information (PII) and/or other data received via a user interface), pre-filled information (e.g., as in the pre-filled information in the UI 205), predicted information (e.g., information about a user that is predicted based on their other information), other information about a user, and/or other information about a request or application submitted by the user. The behavior data 550 in the behavior data 550 data store(s) can include information about a user's loyalty to a merchant or store, a user purchase history, a purchase history associated with a merchant, data from merchant(s), other behavior data, or combinations thereof. The prior offer data 555 in the prior offer data 555 data store(s) can include information about prior offer(s) that a user qualified for, prior offer(s) that a user failed to qualify for, prior offer(s) that were recommended to a user, prior offer(s) that were not recommended to a user, prior offer(s) that are still open to a user (e.g., the offer(s) were provided to the user and still have not expired), prior offer(s) that have expired and are no longer open to the user, offer(s) on file, installment holds, data about persistence of offers, other prior offers, or combinations thereof. The merchant configuration data 560 in the merchant configuration data 560 data store(s) can include merchant preferences, merchant settings, merchant business rules, merchant-specific APRs, merchant-specific interest rates, merchant-preferred products, merchant-specific products (e.g., private label credit cards), or combinations thereof. The rules data 565 in the rules data 565 data store(s) can include credit strategy rules for credit eligibility decisions (e.g., to determine if a user qualifies for a given product), fraud strategy rules for fraud checks (e.g., for fraud attempt detection), or combinations thereof. The scoring data 570 in the scoring data 570 data store(s) can include credit scores, fraud scores, and/or other scores, with may be calculated internally (e.g., by the offer engine 505 or an associated system) and/or externally (e.g., by a credit bureau or other institution).

In some examples, the multi-product qualification analysis system 500 can generate the decisions regarding pulling the various levers 510 dynamically and in real-time as the information from the various data sources (e.g., application data 545 data store(s), behavior data 550 data store(s), prior offer data 555 data store(s), merchant configuration data 560 data store(s), rules data 565 data store(s), scoring data 570 data store(s)) continues to be received by, and/or updated at, the multi-product qualification analysis system 500. This can ensure that the decisions regarding pulling the various levers 510 are made based on up-to-date information from the data sources and/or considerations 540.

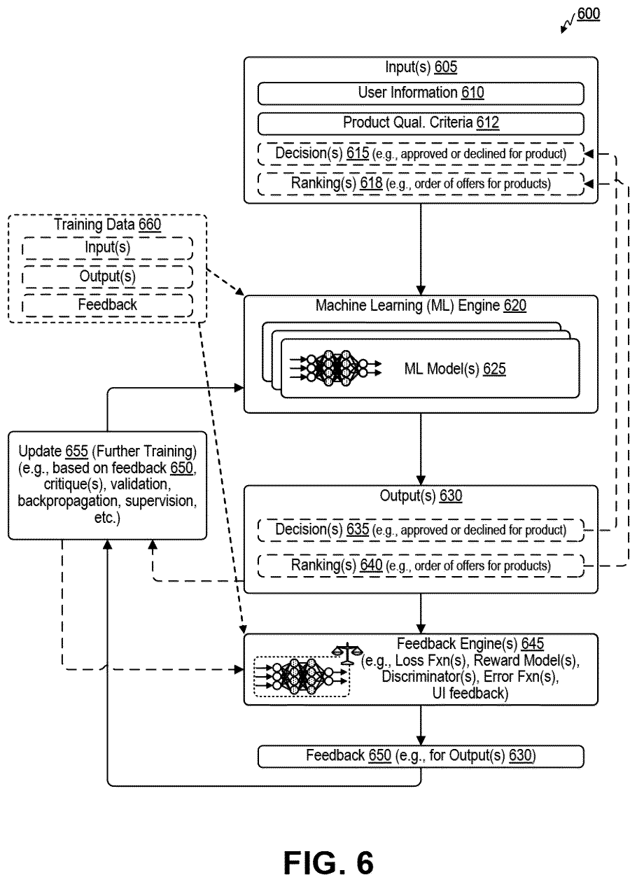

FIG. 6 is a block diagram illustrating an example of a machine learning system 600 for training and use of one or more machine learning model(s) 625 used to generate one or more decision(s) 635 on whether a user is qualified for a given product, and/or to generate ranking(s) 640 indicating an order in which to arrange a list of recommendations for products that a user is qualified for. The machine learning system 600 a machine learning (ML) engine 620 that generates, trains, uses, and/or updates one or more ML model(s) 625. The ML model(s) 625 can include, for instance, one or more neural network (NN(s)), convolutional NN(s) (CNN(s)), trained time delay NN(s) (TDNN(s)), deep network(s), autoencoder(s) (AE(s)), variational AE(s) (VAE(s)), deep belief net(s) (DBN(s)), recurrent NN(s) (RNN(s)), generative adversarial network(s) (GAN(s)), conditional GAN(s) (cGAN(s)), support vector machine(s) (SVM(s)), random forest(s) (RF(s)), decision tree(s), NN(s) with fully connected (FC) layer(s), NN(s) with convolutional layer(s), computer vision system(s), deep learning system(s), classifier(s), transformer(s), clustering algorithm(s), reinforcement learning model(s), supervised learning model(s), unsupervised learning model(s), gradient boosting model(s), sequence-to-sequence (Seq2Seq) model(s), autoregressive (AR) model(s), large language model(s) (LLMs), or combinations thereof. Examples of LLMs that can be used can include, for instance, a Generative Pre-Trained Transformer (GPT) (e.g., GPT-2, GPT-3, GPT-3.5, GPT-4, and/or other GPT variant(s)). DaVinci, an LLM using Massachusetts Institute of Technology (MIT) langchain, Google® Bard®, Google® Gemini®, Large Language Model Meta AI (LLaMA), another LLM, or a combination thereof.

Within FIG. 6, a graphic representing the ML model(s) 625 illustrates a set of circles connected to one another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. An ML model can include more or fewer hidden layers than the two illustrated, but includes at least one hidden layer. In some examples, the layers and/or nodes represent interconnected filters, and information associated with the filters is shared among the different layers with each layer retaining information as the information is processed. The lines between nodes can represent node-to-node interconnections along which information is shared. The lines between nodes can also represent weights (e.g., numeric weights) between nodes, which can be tuned, updated, added, and/or removed as the ML model(s) 625 are trained and/or updated. In some cases, certain nodes (e.g., nodes of a hidden layer) can transform the information of each input node by applying activation functions (e.g., filters) to this information, for instance applying convolutional functions, downscaling, upscaling, data transformation, and/or any other suitable functions.

In some examples, the ML model(s) 625 can include a feed-forward network, in which case there are no feedback connections where outputs of the network are fed back into itself. In some cases, the ML model(s) 625 can include a recurrent neural network, which can have loops that allow information to be carried across nodes while reading in input. In some cases, the network can include a convolutional neural network, which may not link every node in one layer to every other node in the next layer.

One or more input(s) 605 can be provided to the ML model(s) 625. The ML model(s) 625 can be trained by the ML engine 620 (e.g., based on training data 660) to generate one or more output(s) 630. In some examples, the input(s) 605 include user information 610. The user information 610 can include, for instance, the user information 105, the user information provided into the UIs of FIG. 2, the user information pre-filled in the UI 205, the user information 305, user information from the data store(s) of FIG. 5 (e.g., application data 545 data store(s), behavior data 550 data store(s), prior offer data 555 data store(s), merchant configuration data 560 data store(s), rules data 565 data store(s), scoring data 570 data store(s)), the user information of operation 805, other user information discussed herein, or a combination thereof. In some examples, the user information 610 can include information about product(s) that a user may be interested in, such as the requested credit limit in field 225 of the UI 220 or the housing ownership in field 230 of the UI 220. In some examples, the user information 610 can include information relevant to whether or not a user might qualify for a given product, such as annual net income (in field 240), asset(s) owned by the user, debts that the user already owes, and the like.

In some examples, the input(s) 605 include product qualification criteria 612. The product qualification criteria 612 can include, for instance, the product qualification criteria 120, the product qualification criteria 130, the product qualification criteria 140, the product qualification criteria 150, the product qualification criteria associated with the products 310, the product qualification criteria of operation 810, other product qualification criteria discussed herein, or combinations thereof. The product qualification criteria 612 may identify criteria (e.g., minimum thresholds, maximum thresholds, acceptable ranges, unacceptable ranges, conditions) for various values (e.g., user income, user assets, user debts) associated with the user information 610 that dictate whether or not a user qualifies for a given product.

The output(s) 630 generated by the ML model(s) 1125 in response to input of the input(s) 605 (e.g., in response to the user information 610 and/or the product qualification criteria 612) into the ML model(s) 1125 can include one or more decision(s) 635 on which product(s) (and/or associated offers) the user is qualified for, and which product(s) (and/or associated offers) the user is not qualified for. Examples of the decision(s) 635 include the recommendations of FIG. 1 (e.g., recommendation 160, recommendation 170, recommendation 180, recommendation 190), the decisions that the user is qualified for the Partnerbrand Credit Card 255 and the Pay Later Loan 260 presented in the UI 250, decision(s) made in the decisioning 315, decision(s) in the table 405 of the decisions (e.g., under the template 415 column), decision(s) in the table 420 of logic (e.g., under the template 445 and/or treatment 450 column(s)), decision(s) that the user is qualified for the products in the UI 470 (e.g., the primary product 455, the secondary product 460, the tertiary product 465), decision(s) made by the offer engine 505, the qualification decision of operation 815, the recommendations of operation 820, other decisions discussed herein, other recommendations discussed herein, or a combination thereof. In some examples, the decision(s) 635 can be used as input(s) 605 to the ML model(s) 625 (e.g., as one of the decision(s) 615) for generating future decision(s) 635, for generating ranking(s) 640, and/or for generating other output(s) 630. In some examples, at least some of the decision(s) 615 in the input(s) 605 represent previously-generated decision(s) that are input into the ML model(s) 625 to generate the decision(s) 635, the ranking(s) 640, and/or other output(s) 630. In some examples, based on receipt of the input(s) 605, the ML model(s) 625 can generate the decision(s) 635 at least in part using generative artificial intelligence (AI) content generation techniques, for instance using an LLM to generate custom text.

The output(s) 630 generated by the ML model(s) 625 in response to input of the input(s) 605 (e.g., in response to the user information 610, the product qualification criteria 612, and/or the decision(s) 615) into the ML model(s) 625 can include ranking(s) 640 indicating the order in which certain products (and/or offers associated with the products, and/or recommendations associated with the products or offers) are to be presented to the user in a user interface. Examples of the ranking(s) 640 include a ranking or order of the recommendations of FIG. 1 (e.g., with the recommendation 160 being primary, the recommendation 180 being secondary, and the recommendation 190 being tertiary as illustrated in the callouts with dashed lines), a ranking or order in which the products are presented in the UI 250 (e.g., with the Partnerbrand Credit Card 255 being primary and the Pay Later Loan 260 being secondary), a ranking or order in which the variants of the Pay Later Loan 260 product are presented in the UI 275, a ranking or order indicated in the offer presentment instructions 335 generated by the logic subsystem 330, a ranking or order indicated in the table 405 of the decisions (e.g., under the template 415 column), a ranking or order indicated in the table 420 of logic (e.g., under the template 445 and/or treatment 450 column(s)), the ranking or order according to which the products are listed in the UI 470 (e.g., the primary product 455, then the secondary product 460, then the tertiary product 465), a ranking or order determined by the offer engine 505, a ranking or order in which the recommendations for the subset of the plurality of products are output in operation 820, other rankings discussed herein, other recommendations discussed herein, or a combination thereof. In some examples, the ML model(s) 625 can identify the ranking(s) 640 based on factor(s) (e.g., factors 325), which may be included in the input(s) 605 and/or in training data 660 that the ML model(s) 625 are trained using. In some examples, the ranking(s) 640 can be used as input(s) 605 to the ML model(s) 625 (e.g., as one of the ranking(s) 618) for generating future decision(s) 635, for generating future ranking(s) 640, and/or for generating other output(s) 630. In some examples, at least some of the ranking(s) 618 in the input(s) 605 represent previously-generated ranking(s) that are input into the ML model(s) 625 to generate the decision(s) 635, the ranking(s) 640, and/or other output(s) 630. In some examples, based on receipt of the input(s) 605, the ML model(s) 625 can generate the ranking(s) 640 at least in part using generative artificial intelligence (AI) content generation techniques, for instance using an LLM to generate custom text.

In some examples, the ML system that includes the ML engine 620 and/or ML model(s) 625 adds the decision(s) 635 and/or the ranking(s) 640 to a data store. Data can be drawn from these data store(s) to use as input(s) 605 for the ML model(s) 625 for generating future decision(s) 635, ranking(s) 640, and/or other output(s) 630.

In some examples, the ML system repeats the process illustrated in FIG. 6 multiple times to generate the output(s) 630 in multiple passes, using some of the output(s) 630 from earlier passes as some of the input(s) 605 in later passes. For instance, in an illustrative example, in a first pass, the ML model(s) 625 can generate the decision(s) 635 based on input of the user information 610 and/or the product qualification criteria 612 into the ML model(s) 625. In a second pass, the ML model(s) 625 can add (e.g., append) the decision(s) 635 to the input(s) 605 (e.g., as the decision(s) 615), and can generate the ranking(s) 640 based on input of the input(s) 605 (e.g., updated to include user information 610, the product qualification criteria 612, and/or the decision(s) 615 from the first pass) into the ML model(s) 625.

In some examples, the ML system includes one or more feedback engine(s) 645 that generate and/or provide feedback 650 about the output(s) 630. In some examples, the feedback 650 indicates how well the output(s) 630 align to corresponding expected output(s), how well the output(s) 630 serve their intended purpose, or a combination thereof. In some examples, the feedback engine(s) 645 include loss function(s), reward model(s) (e.g., other ML model(s) that are used to score the output(s) 630), discriminator(s), error function(s) (e.g., in back-propagation), user interface feedback received via a user interface from a user, or a combination thereof. In some examples, the feedback 650 can include one or more alignment score(s) that score a level of alignment between the output(s) 630 and the expected output(s) and/or intended purpose.

The ML engine 620 of the ML system can update (further train) the ML model(s) 625 based on the feedback 650 to perform an update 655 (e.g., further training) of the ML model(s) 625 based on the feedback 650. In some examples, the feedback 650 includes positive feedback, for instance indicating that the output(s) 630 closely align with expected output(s) and/or that the output(s) 630 serve their intended purpose. In some examples, the feedback 650 includes negative feedback, for instance indicating a mismatch between the output(s) 630 and the expected output(s), and/or that the output(s) 630 do not serve their intended purpose. For instance, high amounts of loss and/or error (e.g., exceeding a threshold) can be interpreted as negative feedback, while low amounts of loss and/or error (e.g., less than a threshold) can be interpreted as positive feedback. Similarly, high amounts of alignment (e.g., exceeding a threshold) can be interpreted as positive feedback, while low amounts of alignment (e.g., less than a threshold) can be interpreted as negative feedback. In response to positive feedback in the feedback 650, the ML engine 620 can perform the update 655 to update the ML model(s) 625 to strengthen and/or reinforce weights associated with generation of the output(s) 630 to encourage the ML engine 620 to generate similar output(s) 630 given similar input(s) 605. In response to negative feedback in the feedback 650, the ML engine 620 can perform the update 655 to update the ML model(s) 625 to weaken and/or remove weights associated with generation of the output(s) 630 to discourage the ML engine 620 from generating similar output(s) 630 given similar input(s) 605. In some examples, the update 655 to the ML model(s) 625 improves the quality and/or accuracy of the output(s) 630 (e.g., of the decision(s) 635 and/or the ranking(s) 640) for further uses of the ML model(s) 625 to generate further output(s) 630.

In an illustrative example, if the ML model(s) 625 generate decision(s) 635 and/or ranking(s) 640 indicating that a user is qualified for a specific product, and ranking that product highly in the user's recommendations, and the feedback 650 indicates that the user ultimately was able to use the specific product to achieve the user's goal (e.g., purchasing a specific item or service), the feedback 650 can be interpreted as positive feedback, strengthening the weights of the ML model(s) 625 that were responsible for generating the decision(s) 635 and/or ranking(s) 640 to encourage generation of similar output(s) 630 given similar input(s) 605. On the other hand, if the ML model(s) 625 generate decision(s) 635 and/or ranking(s) 640 indicating that a user is qualified for a specific product, and ranking that product highly in the user's recommendations, and the feedback 650 indicates that the user ultimately was unable to use the specific product to achieve the user's goal (e.g., the user was unable to purchase a specific item or service using the product), the feedback 650 can be interpreted as negative feedback, weakening the weights of the ML model(s) 625 that were responsible for generating the decision(s) 635 and/or ranking(s) 640 to discourage generation of similar output(s) 630 given similar input(s) 605.

In some examples, the ML engine 620 can also perform an initial training of the ML model(s) 625 before the ML model(s) 625 are used to generate the output(s) 630 based on the input(s) 605. During the initial training, the ML engine 620 can train the ML model(s) 625 based on training data 660. In some examples, the training data 660 includes examples of input(s) (of any input types discussed with respect to the input(s) 605), output(s) (of any output types discussed with respect to the output(s) 630), and/or feedback (of any feedback types discussed with respect to the feedback 650). In an illustrative example, the training data 660 can include user information (as in the user information 610), product qualification criteria (as in the product qualification criteria 612), decision(s) that correspond to the user information and the product qualification criteria (as in the decision(s) 635), and feedback indicating whether the decision(s) are appropriate given the user information and the product qualification criteria. In a second illustrative example, the training data 660 can include user information (as in the user information 610), product qualification criteria (as in the product qualification criteria 612), decision(s) that correspond to the user information and the product qualification criteria (as in the decision(s) 615 and/or the decision(s) 635), ranking(s) that correspond to the decision(s) (e.g., as in the ranking(s) 640), and feedback indicating whether the ranking(s) are appropriate given the decision(s), the user information, and/or the product qualification criteria. In some cases, positive feedback in the training data 660 can be used to perform positive training, to encourage the ML model(s) 625 to generate output(s) similar to the output(s) in the training data given input of the corresponding input(s) in the training data. In some cases, negative feedback in the training data 660 can be used to perform negative training, to discourage the ML model(s) 625 from generate output(s) similar to the output(s) in the training data given input of the corresponding input(s) in the training data.

In some examples, the ML model(s) 625 can generate the output(s) 630 (e.g., the decision(s) 635 and/or the ranking(s) 640) dynamically and in real-time as the input(s) 605 (e.g., the user information 610, the product qualification criteria 612, the decision(s) 615, and/or the ranking(s) 640) continue to be received by the ML model(s) 625. This can ensure that the output(s) 630 (e.g. the decision(s) 635 and/or the ranking(s) 640) are generated based on up-to-date input(s) 605.

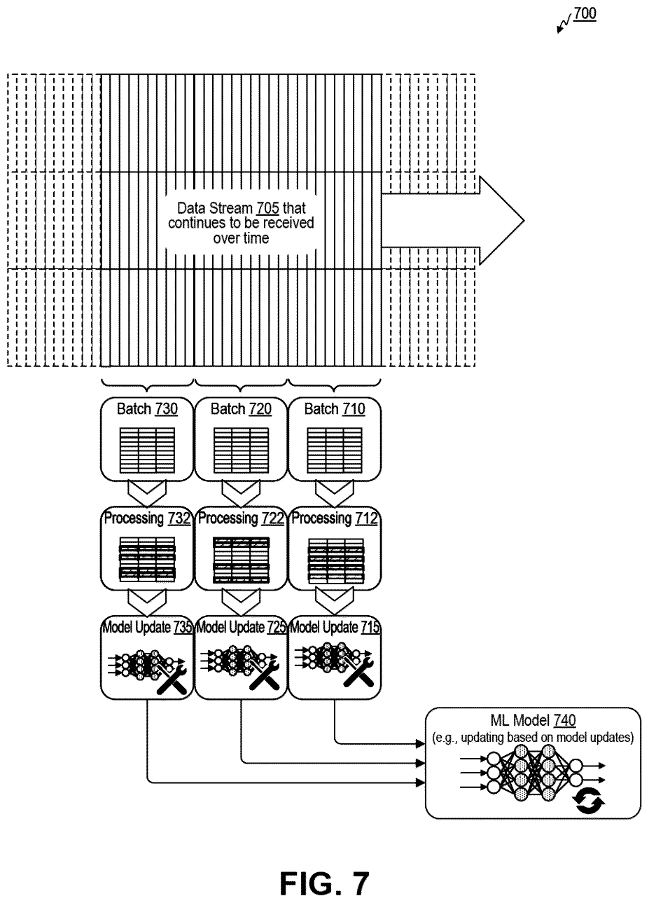

FIG. 7 is a conceptual diagram illustrating a process 700 for dynamically updating a machine learning model 740 in a continuous fashion as further data continues to be received over time. A data stream 705 is illustrated, which can represent, for instance, a stream of data to be input into the machine learning model 740 and/or that the machine learning model 740 is to be trained, retrained, fine-tuned, and/or updated based on. The data stream 705 includes large quantities of data that continue to come on over a long period of time. In some examples, a system (e.g., the special-purpose management computer system(s) 110, offer engine 505) can extract batches of data (e.g., batch 710, batch 720, batch 730) from the data stream dynamically and in real-time (or near-real-time) as the data from the data stream 705 continues to be received by the system. In some examples, the system (e.g., the special-purpose management computer system(s) 110, offer engine 505) can process the batches of data dynamically and in real-time (or near-real-time) as the data from the data stream 705 continues to be received by the system to generate model updates. The model updates can include training data, fine-tuning data, context data, model parameters (e.g., temperature, top P, frequency penalty, presence penalty and/or other parameters or settings) for training, re-training, fine-tuning, and/or updating the machine learning model 740. For instance, the batch 710 undergoes processing 712 to generate the model update 715. The batch 720 undergoes processing 722 to generate the model update 725. The batch 730 undergoes processing 732 to generate the model update 735. The system (e.g., the ML engine 620 and/or the special-purpose server system(s) 110) trains, retrains, fine-tunes, and/or updates the machine learning model 740 based on the model update 715, the model update 725, and/or the model update 735, sequentially, in parallel, and/or in further batches of model updates. In this way, the system (e.g., the ML engine 620 of the special-purpose management computer system(s) 110) continues to dynamically train, retrain, fine-tune, and/or update the machine learning model 740 in real-time (or near-real-time) as the data from the data stream 705 continues to be received by the system.

In some examples, the data stream 705 may include, for instance, the user information 105, the product qualification criteria 120, the product qualification criteria 130, the product qualification criteria 140, the product qualification criteria 150, UI inputs (e.g., via UI 205, UI 220, UI 250, UI 270, UI 275, and/or UI 470), the user information 305, the identities of the products 310, the offers 320, the factors 325, any of the information in the table 405, any of the information in the table 420, any of the various considerations 540, the application data 545, the behavior data 550, the prior offer data 555, the merchant configuration data 560, the rules data 565, the scoring data 570, the input(s) 605, the user information 610, the product qualification criteria 612, prior decision(s) 615, prior ranking(s) 618, the user information of operation 805, the product qualification criteria data of operation 810, or a combination thereof. In some examples, the processing 712, the processing 722, and/or the processing 732, can include processing operations such as those discussed with respect to the special-purpose management computer system(s) 110, the logic subsystem 330, the update 365, the processing 370, the table 405, the table 420, the offer engine 505, the ML model(s) 625, or a combination thereof. In some examples, the updates to the machine learning model 740 (e.g., model update 715, model update 725, model update 735) can be similar to the update 655 to the ML model(s) 625. In some examples, the machine learning model 740 may be an example of the engine(s) 127, the engine(s) 137, the engine(s) 147, the engine(s) 157, at least a portion of the logic subsystem 330, at least a portion of the offer engine 505, the ML model(s) 625, the trained ML model of operation 815 and/or operation 825, or a combination thereof.

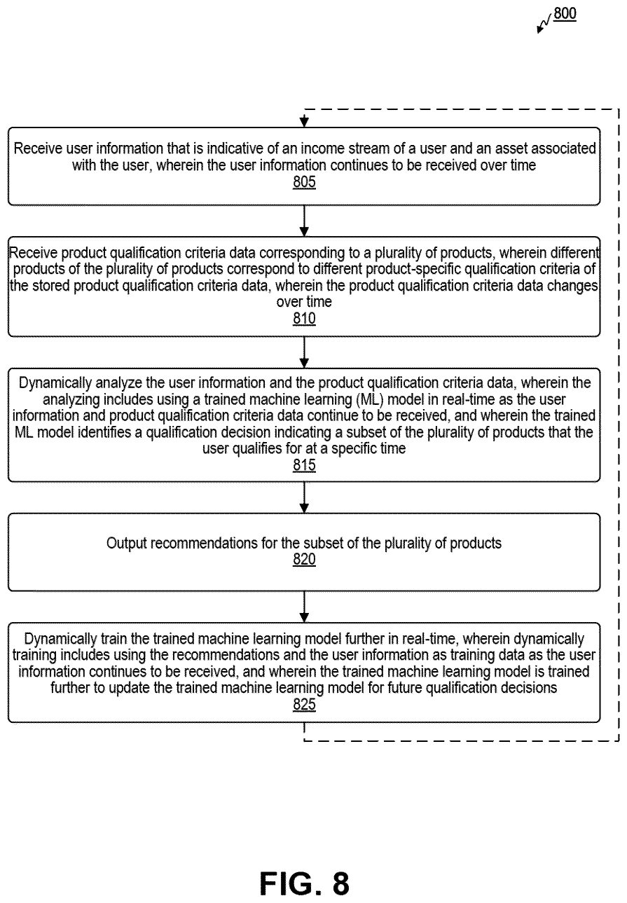

FIG. 8 is a flow diagram illustrating a process 800 for qualification analysis. The process 800 may be performed by a qualification analysis system. In some examples, the enrollment orchestration system can include, for example, the multi-product qualification analysis system 100, the user device that displays the user interfaces of FIG. 2 (e.g., user interface 205, user interface 220, user interface 250, user interface 270, user interface 275), the multi-product qualification analysis system 300, the user device that displays the user interface 470, the multi-product qualification analysis system 500, the machine learning system 600, the computing system 900, the processor 910, and sub-system or component of any of the previously-listed systems, an apparatus, a system, a non-transitory computer-readable medium coupled to a processor, or a combination thereof.

At operation 805, the qualification analysis system (or a component or subsystem thereof) is configured to, and can, receive user information that is indicative of an income stream of a user and an asset associated with the user, wherein the user information continues to be received over time. Examples of the user information include the user information 105, the user information provided into the UIs of FIG. 2, the user information pre-filled in the UI 205, the user information 305, user information from the data store(s) of FIG. 5 (e.g., application data 545 data store(s), behavior data 550 data store(s), prior offer data 555 data store(s), merchant configuration data 560 data store(s), rules data 565 data store(s), scoring data 570 data store(s)), the user information 610, the data stream 705, the batch 710, the batch 720, the batch 730, other user information discussed herein, or a combination thereof.

In some examples, the user information is received through a graphical user interface (GUI) (e.g., UI 205, UI 220, UI 275). In some examples, a first portion of the user information (e.g., the SSN, ITIN, and/or TIN in field 210) is received through a graphical user interface (GUI), and a second portion of the user information (e.g., the pre-filled information of the UI 205) is retrieved from a database based on a query using the first portion of the user information.

At operation 810, the qualification analysis system (or a component or subsystem thereof) is configured to, and can, receive product qualification criteria data corresponding to a plurality of products, wherein different products of the plurality of products correspond to different product-specific qualification criteria of the product qualification criteria data, wherein the product qualification criteria data changes over time. Examples of the product qualification criteria data include the product qualification criteria 120, the product qualification criteria 130, the product qualification criteria 140, the product qualification criteria 150, the product qualification criteria associated with the products 310, the product qualification criteria 612, product qualification criteria in the data stream 705, other product qualification criteria discussed herein, or combinations thereof. Examples of the plurality of the products include the product 125, the product 135, the product 145, the product 155, the Partnerbrand Credit Card 255 product, the Pay Later Loan 260 product, the variants of the Pay Later Loan 260 product identified in the UI 275, the products 310, the credit card 410, the installment loan 412, the primary product 455, the secondary product 460, the tertiary product 465, the products 515, product(s) associated with the product qualification criteria 612, product(s) about which the decision(s) 635 are made, product(s) ranked by the ranking(s) 640, product(s) with associated data in the data stream 705, other products discussed herein, or combinations thereof.

At operation 815, the qualification analysis system (or a component or subsystem thereof) is configured to, and can, dynamically analyze the user information and the product qualification criteria data, wherein the analyzing includes using a trained machine learning (ML) model in real-time as the user information and the product qualification criteria data continue to be received, and wherein the trained ML model identifies a qualification decision indicating a subset of the plurality of products that the user qualifies for at a specific time. Examples of the trained ML model include the AI engine(s) 127, the AI engine(s) 137, the AI engine(s) 147, the AI engine(s) 157, the decisioning 315, the logic subsystem 330, the offer engine 505, the ML model(s) 625, the machine learning model 740, other AI system(s) discussed herein, other ML model(s) discussed herein, or a combination thereof. Examples of the qualification decision include the recommendation 160, the recommendation 170, the recommendation 180, the recommendation 190, the decisions that the user qualified for the Partnerbrand Credit Card 255 product and the Pay Later Loan 260 product in the UI 250, the decisioning 315, decision(s) made in the decisioning 315, decision(s) in the table 405 of the decisions (e.g., under the template 415 column), decision(s) in the table 420 of logic (e.g., under the template 445 and/or treatment 450 column(s)), decision(s) that the user is qualified for the products in the UI 470 (e.g., the primary product 455, the secondary product 460, the tertiary product 465), decision(s) made by the offer engine 505, the decision(s) 615, the decision(s) 635, other decisions discussed herein, other recommendations discussed herein, or a combination thereof.

At operation 820, the qualification analysis system (or a component or subsystem thereof) is configured to, and can, output recommendations for the subset of the plurality of products. Examples of the recommendations include the recommendation 160, the recommendation 170, the recommendation 180, the recommendation 190, the recommendations of the Partnerbrand Credit Card 255 product and the Pay Later Loan 260 product in the UI 250, the presented offers 350 in the UI 340, the recommendations in the template 415 column of the table 405 of decisions, the recommendations in the template 445 and/or treatment 450 columns of the table 420 of logic, the recommendations of the primary product 455 and the secondary product 460 and the tertiary product 465, recommendations output by the offer engine 505, other recommendations discussed herein, or combinations thereof.

In some examples, the subset of the plurality of products includes at least a first product of a first type and a second product of a second type. In some examples, the subset of the plurality of products includes at least one of a credit card or a loan.

In some examples, the recommendations for the subset of the plurality of products include a first recommendation for a first product of the subset of the plurality of products and a second recommendation for a second product of the subset of the plurality of products.

In some examples, the qualification analysis system (or a component or subsystem thereof) is configured to, and can, receive a selection of a particular product from the subset of the plurality of products in response to outputting the recommendations; and initiate an onboarding of the user for the particular product based on the selection and based on the user qualifying for the particular product. Examples of onboarding include the onboarding 165, the onboarding 175, the onboarding 185, the onboarding 195, the button in the UI 250 that leads to the UI 270, the UI 270, the button in the UI 250 that leads to the UI 275, the UI 275, the presenting of offers 350 through the UI 340, the “accept” buttons of the UI 470, other onboarding elements discussed herein, or combinations thereof.

In some examples, the qualification analysis system (or a component or subsystem thereof) is configured to, and can, rank the subset of the plurality of products to determine an order in which to recommend the subset of the plurality of products, wherein outputting the recommendations for the subset of the plurality of products is done according to the order.

In some examples, the analyzing (of operation 815) includes using a second trained machine learning (ML) model in real-time as the user information and the product qualification criteria data continue to be received, and wherein the second trained ML model ranks the subset of the plurality of products to determine an order in which to recommend the subset of the plurality of products, wherein outputting the recommendations for the subset of the plurality of products is done according to the order. In some examples, the trained ML model is the second trained ML model (e.g., the trained ML model and the second trained ML model are the same model).

Examples of the rankings include a ranking or order of the recommendations of FIG. 1 (e.g., with the recommendation 160 being primary, the recommendation 180 being secondary, and the recommendation 190 being tertiary as illustrated in the callouts with dashed lines), a ranking or order in which the products are presented in the UI 250 (e.g., with the Partnerbrand Credit Card 255 being primary and the Pay Later Loan 260 being secondary), a ranking or order in which the variants of the Pay Later Loan 260 product are presented in the UI 275, a ranking or order indicated in the offer presentment instructions 335 generated by the logic subsystem 330, a ranking or order indicated in the table 405 of the decisions (e.g., under the template 415 column), a ranking or order indicated in the table 420 of logic (e.g., under the template 445 and/or treatment 450 column(s)), the ranking or order according to which the products are listed in the UI 470 (e.g., the primary product 455, then the secondary product 460, then the tertiary product 465), a ranking or order determined by the offer engine 505, the ranking(s) 618, the ranking(s) 640, other rankings discussed herein, other recommendations discussed herein, or a combination thereof

In some examples, the qualification analysis system (or a component or subsystem thereof) is configured to, and can, identify a change in the user information; and identify a change in the subset of the plurality of products that the user qualifies for based on the change in the user information.

In some examples, the qualification analysis system (or a component or subsystem thereof) is configured to, and can, identify a change in the product qualification criteria data; and identify a change in the subset of the plurality of products that the user qualifies for based on the change in the product qualification criteria data.

At operation 825, the qualification analysis system (or a component or subsystem thereof) is configured to, and can, dynamically train the trained machine learning model further in real-time, wherein dynamically training includes using the recommendations and the user information as training data as the user information continues to be received, and wherein the trained machine learning model is trained further to update the trained machine learning model for future qualification decisions. Examples of the further training and/or updating include the feedback loop 360, the update 655, the model update 715, the model update 725, the model update 735, or a combination thereof.

In some examples, the processes described herein may be performed by a computing device or apparatus. The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes described herein are illustrated as logical flow diagrams, block diagrams, or conceptual diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

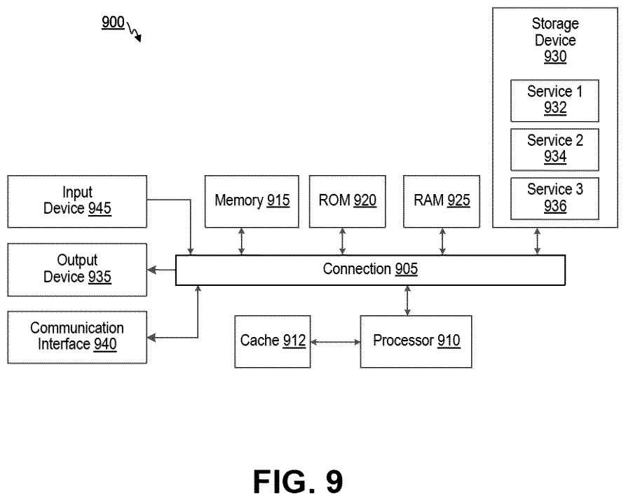

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 902.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

1. A method for automated ranked multi-product qualification analysis, the method comprising:
receiving user information that is indicative of an income stream of a user and an asset associated with the user, wherein the user information continues to be received over time;
receiving product qualification criteria data corresponding to a plurality of products, wherein different products of the plurality of products correspond to different product-specific qualification criteria of the product qualification criteria data, and wherein the product qualification criteria data changes over time;
dynamically processing the user information and the product qualification criteria data using a trained machine learning (ML) model to generate a qualification decision and a ranking, wherein the trained ML model processes the user information and the product qualification criteria data in real-time as the user information and the product qualification criteria data continue to be received, wherein the qualification decision indicates a subset of the plurality of products that the user qualifies for at a specific time, wherein the subset includes an installment loan, wherein the ranking indicates an order in which to recommend different products in the subset based on relevance to the user, and wherein processing is based on numeric weights of the trained ML model;
outputting recommendations for the subset according to the order;
receiving an input corresponding to a selection of a product from the recommendations; and
dynamically updating the trained ML model in real-time, wherein updating includes using at least the subset and the selection as training data, wherein updating includes adjusting at least one of the numeric weights, and wherein the trained ML model is updated to improve an accuracy of the trained ML model for future qualification decisions.

2. The method of claim 1, wherein the subset of the plurality of products includes at least a first product of a first type and a second product of a second type.

3. The method of claim 1, wherein the user information is received through a graphical user interface (GUI).

4. The method of claim 1, wherein a first portion of the user information is received through a graphical user interface (GUI), and wherein a second portion of the user information is retrieved from a database based on a query using the first portion of the user information.

5. The method of claim 1, wherein the recommendations for the subset of the plurality of products include a first recommendation for a first product of the subset of the plurality of products and a second recommendation for a second product of the subset of the plurality of products.

6. The method of claim 1, further comprising:
receiving a selection of a particular product from the subset of the plurality of products in response to outputting the recommendations; and
initiating an onboarding of the user for the particular product based on the selection and based on the user qualifying for the particular product.

7. The method of claim 1, wherein the subset includes the installment loan and a credit card.

8. The method of claim 1, wherein updating includes using at least the subset, the ranking, and the selection as the training data.

9. The method of claim 1, wherein processing the user information and the product qualification criteria data using the trained ML model to generate the qualification decision and the ranking includes:
processing the user information and the product qualification criteria data using the trained ML model to generate the qualification decision; and
processing the user information and the product qualification criteria data using a second trained ML model to generate the ranking.

10. The method of claim 1, further comprising:
identifying a change in the user information; and
identifying a change in the subset of the plurality of products that the user qualifies for based on the change in the user information.

11. The method of claim 1, further comprising:
identifying a change in the product qualification criteria data; and
identifying a change in the subset of the plurality of products that the user qualifies for based on the change in the product qualification criteria data.

12. The method of claim 1, wherein the subset of the plurality of products includes at least one of a credit card or a loan.

13. A system for automated ranked multi-product qualification analysis, the system comprising:
at least one memory storing instructions; and
at least one processor, wherein execution of the instructions by the at least one processor causes the at least one processor to:
receive user information that is indicative of an income stream of a user and an asset associated with the user, wherein the user information continues to be received over time;
receive product qualification criteria data corresponding to a plurality of products, wherein different products of the plurality of products correspond to different product-specific qualification criteria of the product qualification criteria data, wherein the product qualification criteria data changes over time;
dynamically process the user information and the product qualification criteria data using a trained machine learning (ML) model to generate a qualification decision and a ranking, wherein the trained ML model processes the user information and the product qualification criteria data in real-time as the user information and the product qualification criteria data continue to be received, wherein qualification decision indicates a subset of the plurality of products that the user qualifies for at a specific time, wherein the subset includes an installment loan, wherein the ranking indicates an order in which to recommend different products in the subset based on relevance to the user, and wherein processing is based on numeric weights of the trained ML model;
output recommendations for the subset according to the order;
receive an input corresponding to a selection of a product from the recommendations; and
dynamically update the trained ML model in real-time, wherein updating includes using at least the subset and the selection as training data information continues to be received, wherein updating includes adjusting at least one of the numeric weights, and wherein the trained ML model is updated to improve an accuracy of the trained ML model for future qualification decisions.

14. The system of claim 13, wherein the subset of the plurality of products includes at least a first product of a first type and a second product of a second type.

15. The system of claim 13, wherein the user information is received through a graphical user interface (GUI).

16. The system of claim 13, wherein a first portion of the user information is received through a graphical user interface (GUI), and wherein a second portion of the user information is retrieved from a database based on a query using the first portion of the user information.

17. The system of claim 13, wherein the recommendations for the subset of the plurality of products include a first recommendation for a first product of the subset of the plurality of products and a second recommendation for a second product of the subset of the plurality of products.

18. The system of claim 13, wherein the execution of the instructions by the at least one processor causes the at least one processor to:
receive a selection of a particular product from the subset of the plurality of products in response to outputting the recommendations; and
initiate an onboarding of the user for the particular product based on the selection and based on the user qualifying for the particular product.

19. The system of claim 13, wherein the subset includes the installment loan and a credit card.

20. The system of claim 13, wherein updating includes using at least the subset, the ranking, and the selection as the training data.

21. The system of claim 13, wherein processing the user information and the product qualification criteria data using the trained ML model to generate the qualification decision and the ranking includes:
processing the user information and the product qualification criteria data using the trained ML model to generate the qualification decision; and
processing the user information and the product qualification criteria data using a second trained ML model to generate the ranking.

22. The system of claim 13, wherein the execution of the instructions by the at least one processor causes the at least one processor to:
identify a change in the user information; and
identify a change in the subset of the plurality of products that the user qualifies for based on the change in the user information.

23. The system of claim 13, wherein the execution of the instructions by the at least one processor causes the at least one processor to:
identify a change in the product qualification criteria data; and
identify a change in the subset of the plurality of products that the user qualifies for based on the change in the product qualification criteria data.

24. The system of claim 13, wherein the subset of the plurality of products includes at least one of a credit card or a loan.

25. A non-transitory computer readable storage medium having embodied thereon a program, wherein the program is executable by a processor to perform a method of automated ranked multi-product qualification analysis, the method comprising:
receiving user information that is indicative of an income stream of a user and an asset associated with the user, wherein the user information continues to be received over time;
receiving product qualification criteria data corresponding to a plurality of products, wherein different products of the plurality of products correspond to different product-specific qualification criteria of the product qualification criteria data, wherein the product qualification criteria data changes over time;
dynamically processing the user information and the product qualification criteria data using a trained machine learning (ML) model to generate a qualification decision and a ranking, wherein the trained ML model processes the user information and the product qualification criteria data in real-time as the user information and the product qualification criteria data continue to be received, wherein the qualification decision indicates a subset of the plurality of products that the user qualifies for at a specific time, wherein the subset includes an installment loan, wherein the ranking indicates an order in which to recommend different products in the subset based on relevance to the user, and wherein processing is based on numeric weights of the trained ML model;
outputting recommendations for the subset according to the order;
receiving an input corresponding to a selection of a product from the recommendations; and
dynamically updating the trained ML model in real-time, wherein updating includes using at least the subset and the selection as training data, wherein updating includes adjusting at least one of the numeric weights, and wherein the trained ML model is updated to improve an accuracy of the trained ML model for future qualification decisions.

26. The non-transitory computer readable storage medium of claim 25, wherein the subset of the plurality of products includes at least a first product of a first type and a second product of a second type.

27. The non-transitory computer readable storage medium of claim 25, wherein the user information is received through a graphical user interface (GUI).

28. The non-transitory computer readable storage medium of claim 25, wherein a first portion of the user information is received through a graphical user interface (GUI), and wherein a second portion of the user information is retrieved from a database based on a query using the first portion of the user information.

29. The non-transitory computer readable storage medium of claim 25, wherein the recommendations for the subset of the plurality of products include a first recommendation for a first product of the subset of the plurality of products and a second recommendation for a second product of the subset of the plurality of products.

30. The non-transitory computer readable storage medium of claim 25, further comprising:
receiving a selection of a particular product from the subset of the plurality of products in response to outputting the recommendations; and
initiating an onboarding of the user for the particular product based on the selection and based on the user qualifying for the particular product.
